(19) United States
(12) Patent Application Publication
(10) Pub. No.: US 2024/0048972 A1
(43) Pub. Date: Feb. 8, 2024

(54) MOBILE INDIVIDUAL SECURE COMMUNICATIONS ENVIRONMENT

(71) Applicant: Anjuma KARKERA, McLean, VA (US)

(72) Inventor: Anjuma KARKERA, McLean, VA (US)

(21) Appl. No.: 18/382,666

(22) Filed: Oct. 23, 2023

Related U.S. Application Data
(63) Continuation-in-part of application No. 17/740,141, filed on May 9, 2022, now abandoned.
(60) Provisional application No. 63/186,482, filed on May 10, 2021.
(60) Provisional application No. 63/332,078, filed on Apr. 18, 2022.

(51) Int. Cl. H04W 12/033; H04W 12/33; H04W 12/06

(52) U.S. Cl. CPC H04W 12/033; H04W 12/33; H04W 12/06

(57) ABSTRACT

Various embodiments include a mobile confidential and secure communication environment system for enabling a user to engage in secure video and audio communications. Various embodiments may include eyewear that includes a display that is configured to display images for viewing by the user while preventing such imagery to be viewed by others, headphones configured to provide audio to the user while preventing sounds from being overheard by other, a mouthpiece including a microphone configured to receive speech spoken by the user while preventing such speech from being overheard by others, a secure communication interface configured to provide a secure communication link to a mobile device or desktop computer and a control unit configured to control the eyewear, headphones, and mouthpiece. Various embodiments may fully integrate sight and voice through technical capabilities to enable a confidential and private communications environment.

### RELATED APPLICATIONS

This application is a continuation-in-part of U.S. patent application Ser. No. 17/740,141 entitled “MOBILE INDIVIDUAL SECURE COMMUNICATIONS ENVIRONMENT” filed May 9, 2022, which claims the benefit of priority to U.S. Provisional Application No. 63/186,482 entitled “MOBILE INDIVIDUAL SECURE COMMUNICATIONS ENVIRONMENT” filed May 10, 2021, and to U.S. Provisional Application No. 63/332,078 entitled “MOBILE INDIVIDUAL SECURE COMMUNICATIONS ENVIRONMENT” filed Apr. 18, 2022, the entire contents of all of which are hereby incorporated by reference for all purposes.

### BACKGROUND

In many corporate, academic, military and government settings, the ability to communicate outside of a facility is restricted by the inability to secure information against electronic surveillance and data leakage. On an individual level, there is a demand to have private communications regardless of location. With an increased desire to be more mobile not tethered to a location and a business requirement to successfully recruit from the global talent, there is a need for a mobile individual secure communications environment integrating the ability to secure sight, sound and speech.

In order to remove physical co-location and effectively operate, there are three communication elements that must be integrated to creating a secure, synchronized capability. The first is visual capability that allows the individual user to see information without exposing it to the sight of others. The second is audio capability that allows the user to hear information without others being able to hear it. And, the third is the voice that allows the user to speak freely without others having access to what is being said. The key is to integrate and synchronize all three of these capabilities to create a single multifunctional and all-encompassing individual mobile secure communications environment. By eliminating or mitigating working from a specific location or, in other words, operating securely regardless of location, it enhances business continuity, continuity of government, addressing emergency situations (e.g., weather events, pandemics, and national emergencies), and evolving the understanding of “going to work”.

Today, there are several ways in which organizations meet the challenge of security, confidentiality, and privacy in an attempt to mitigate the requirement of physical co-location. In all cases, a secure room, even for an individual, is required to prevent unauthorized electronic surveillance and data leakage. In the case of the Department of Defense, they use a Sensitive Compartmented Information Facility (SCIF) which is a term for a secure room that is a certified structure to guard against electronic surveillance and data leakage. It also prevents access by unauthorized people for purposes of protecting confidential and secure material. A SCIF requires physical security, acoustic protections, visual controls, mechanical/electrical/plumbing (MEP) systems, electronic access control systems (ACS), intrusion detection and electromagnetic shielding (RF shielding). There are “mobile” SCIFs available which are SCIFs on wheels and don't readily afford individual mobility.

In addition, corporate and academic organizations require that access-controlled information (e.g., confidential, trademark, copyright, or formula-based content) be viewed in a secure environment which may involve a monitored room. The limitations and restrictions are largely based on the inability to secure and protect the information from unauthorized viewing and hearing of the information.

Everyone has an interest, at times, in keeping their conversations, and mobile device screens private. So, they cover their mouth and shield their device screens with their hand and use forms of noise cancelling headphones to block out sound they do not want to share or hear. While existing capabilities address some of the concerns individually, no existing capability addresses the ability to secure sight, hearing and voice in a single device.

### SUMMARY

Various embodiments described herein include methods and devices for providing a mobile confidential and secure communication environment by integrating and augmenting technical capability which may negate or limit the need for a facility and minimizes the lack of communication privacy in many settings. Various embodiments integrate a sound cancelling mouthpiece module and earpiece module, and a virtual smart eyewear module that have the ability to make any monitor or screen invisible to anybody other than the user of the eyewear. With the synchronization of these capabilities, various embodiments provide a fully integrated individual, mobile, secure, and confidential communication environment for the user.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a diagram illustrating major components of an example embodiment.

FIG. 2 is a software block diagram illustrating software modules and subsystems of an example embodiment.

FIG. 3 is a hardware block diagram illustrating hardware components and subsystems of an example embodiment.

FIGS. 4A-4C are diagrams illustrating major components of a first alternative example embodiment.

FIG. 5 is a diagram illustrating selected components of the first alternative example embodiment.

FIGS. 6A and 6B are diagrams illustrating major components of a second alternative example embodiment.

FIG. 7 is a diagram illustrating the second alternative example embodiment being worn by a user.

FIGS. 8A-8C are diagrams illustrating major components of a third alternative example embodiment.

### DETAILED DESCRIPTION

Various embodiments provide a mobile confidential and secure communication environment system that includes a headset containing a control unit that is coupled to headphones, a mouthpiece with soundproof padding or sound canceling mechanisms to muffle a user's voice, and a private display in the form of eyewear that allows the user to view the information but not others. The soundproof padding or sound canceling mechanisms to muffle a user's voice of various embodiments prevents eavesdropping on what the user says. The private display prevents others from viewing displayed information. The system as a whole, with all its sub-systems and components, includes radio frequency (RF) shielding to protect against leakage of electromagnetic signals that could vulnerable to electronic eavesdropping. The integrated combination of all of these subsystems and components provides a mobile confidential and secure communication environment.

Various embodiments may utilize a microcontroller unit (MCU) within the control unit that is configured with processor-executable instructions to be connected to any mobile communication and computing device (e.g., a phone, laptop, or table) or desktop computers. The control unit and/or the MCU may utilize intelligent firmware for decision making and controlling communication functions as well as functions of the headphones, mouthpiece and private display, with the firmware configured to be upgraded on site or over a network. The control unit may also have memory storage. The control unit and/or the MCU may be configured with processor-executable instructions to provide a secure virtual machine (e.g., Citrix®) to provide a unique virtual operating system and desktop.

The mobile confidential and secure communication environment according to various embodiments may include virtual smart eyewear: The purpose of the eyewear is to provide a private display that makes all visual information visible exclusively to the user. The eyewear may integrate with any mobile devices (phone, laptop, or table) or desktop computer to virtually display information to the user and make it shielded to anybody other than the user of the eyewear. Through a secure connection to a mobile device, the eyewear can also be connected to the secure virtual machine (e.g., Citrix®) implemented in the control unit.

The mobile confidential and secure communication environment system is configured to prevent those that are not intended to have access to the information that is being communicated visually and audibly, preventing disclosure of sensitive information through sight, voice, audio, or electronic eavesdropping. In other words, the mobile confidential and secure communication environment according to various embodiments will enable only those that are the intended recipients of information to hear and see the information.

The mobile confidential and secure communication environment system may be connected to a user's electronic device (e.g., a smart phone, laptop computer, desktop computer, secure telephone, etc.) that contains and/or communicates protected information, or has the ability to access such information through appropriate software that allows access to protected information (e.g., a Citrix or any cloud based application). The system according to various embodiments may be connected to the user's electronic device, and the user may be authenticated through one or more multi-factor authentication methods (e.g., retinal scan, fingerprint scan, multifactor sign in, etc.) that are enabled by sensors on one or more components or subsystems on the mobile confidential and secure communication environment system to confirm the identity of the user prior to commencing secure communications. Further, user sensor on the headset and/or other subsystems may continuously provide data to the control unit regarding whether the user is still wearing the headset, mouthpiece and private display to ensure continuous secure wearing of the system, with the control unit configured to terminate emission of sound and display of information if/when the user removes one or more of the subsystems.

In various embodiments, when the mobile confidential and secure communication environment system is turned on, communications between the system and the connected electronic device will result in the connected electronic device discontinuing output of communicated information on the display and from the speakers, with images and sound routed to the mobile confidential and secure communication environment system. A user wearing the device according to various embodiments will then have access to the information as long as the device is continuously and securely worn by the user. If the device is removed by the user or disconnected from its sensors that ensure proper secure wearing, the information will longer be shared (visible or heard) through the system.

In some embodiments, the user may be able to engage portions of the integrated mobile confidential and secure communication environment. For example, if the information is only visible (i.e., images or video presented on the eyewear), the user would not have to engage or use the audio and voice capabilities. Accordingly, the control unit may be configured to enable use of either the earphones if only audio information is being provided or the eyewear if only visible information is being presented without requiring the user to wear the other device. The ability to use various portions of the device may enhance the user experience.

The integrated mobile confidential and secure communication environment according to various embodiments may be used in a variety of situations in which the user has a desire or need to receive private information and reply by voice in a secure manner without the risk of received information being intercepted by others or the user being overheard. For example, the integrated mobile confidential and secure communication environment may be used in the intelligence community and other federal government agencies to access classified and/or protected information in a secure manner when outside of a SCIF, such as in a war zone, while performing government related inspections, or while engaged in government related audits. As another example, the integrated mobile confidential and secure communication environment may be useful in the corporate environment, such as when a group discussion needs to share proprietary information in confidence, such as board meetings, financial document reviews, legal or court related proceedings, sensitive inspections, and the like. As a further example, the integrated mobile confidential and secure communication environment may serve a variety of personal uses, such as to help minimize intrusion or disruption while engaging in a personal conversation in a public setting without interruption or eavesdropping by others (e.g., in a crowded environment, on public transportation, etc.).

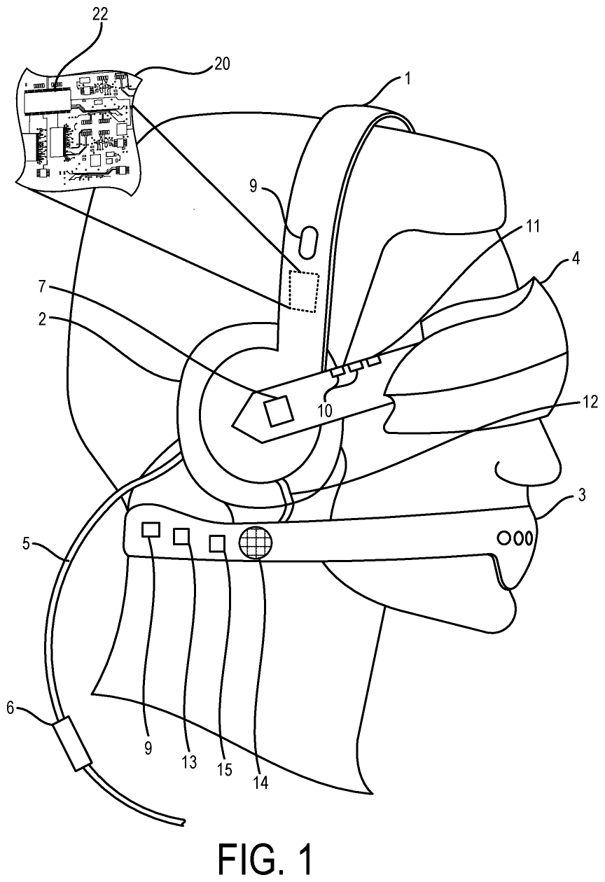

FIG. 1 is a diagram illustrating major components of an example embodiment of an integrated mobile confidential and secure communication environment system. With reference to FIG. 1, the integrated mobile confidential and secure communication environment system may include a headset 1 that includes or is coupled to headphones 2, a private display in the form of eyewear 4 that allows the information on a mobile device or desktop to be visualized from the user but not others, and a sound canceling mouthpiece 3. As illustrated, these three subsystems or components are connect together into an integrated system configured and controlled by a control unit 20.

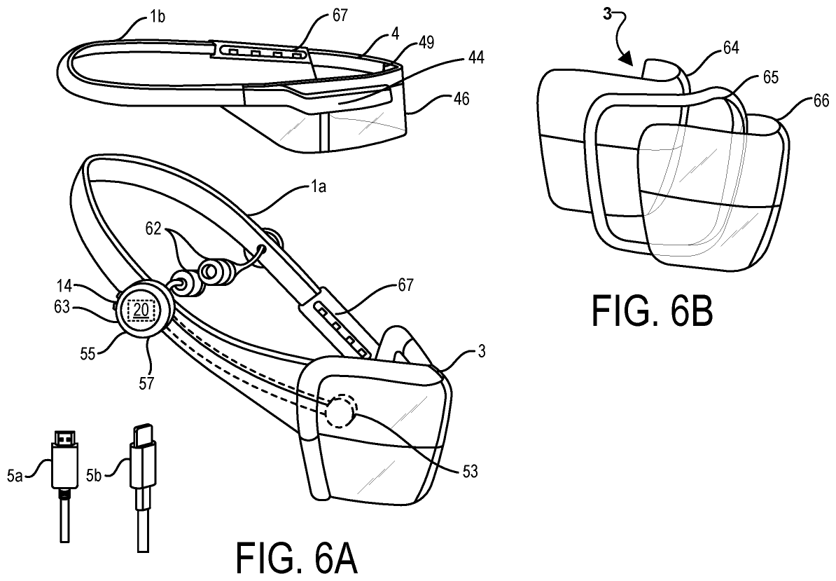

As noted above, the mobile confidential and secure communication environment system includes a control unit 20, which may include circuitry and an MCU 22 configured with processor-executable instructions to perform various functions of the system. In the embodiment illustrated in FIG. 1, the control unit 20 is included within the headset 1. However, the control unit 20 may be positioned in any one or more of the headset 1, headphones 2 (as shown in FIG. 6A), mouthpiece 3, and/or eyewear 4. Further, the system may include more than one control unit 20, with multiple control units configured to coordinate various functions of the system.

The control unit 20 may be configured to integrate the sub-components of the eyewear 4, earbuds 62 and mouthpiece 3 into a secure communication environment. The control unit 20 may act as a brain to the system by enabling and disabling the sub-components based on user authentication and proper use of the headphones 2, eyewear 4 and/or mouthpiece 3. The control unit 20 may also be responsible for interfacing with any mobile or desktop to establish a secure connection and ensuring a mobile confidential and secure communication environment. The control unit 20 may also contain auxiliary battery and power management modules to support functioning and information processing of the system. The control unit 20 may also control biometric sensors, such as a fingerprint scanner, for performing multi-factor authentication of the user.

The control unit 20 may also have encryption and decryption capabilities implemented through software and hardware modules. For cryptographic functionalities the control unit may use Z and Real Time Protocol for creating a security layer through negotiating a secure key with the remote server or receiving device which then stores or periodically re-validates ZRTP Short Authentication String (SAS). This secure key may be used by the sub modules, like the mouthpiece 3 to encrypt audio input data or earphone 2 to decrypt audio output data for user consumption as described herein.

In various embodiments, the control unit 20 may be configured with software or firmware programming to control operations of the mobile confidential and secure communication environment system to enable use of the system while preventing leakage or disclosure of sensitive information during a secure communication session. Nonlimiting examples of functions performed by the control unit 20 include: identifying or authenticating the user (e.g., using biometric authentication methods); enabling use of the system in response to authenticating the user and preventing use of the system by unauthorized people; confirming that system components (e.g., headset 1, headphones 2 (or earbuds) mouthpiece 3 and/or eyewear 4) are being properly worn by the user before enabling use of the system as well as terminating a secure session in response to a components being taken off by the user; establishing a secure communication link with another computing device, including negotiating communication parameters and encryption keys, as well as encrypting and decrypting data enabling the communication session; monitoring security features on the system that may detect RF or audio leakage; and other functions to ensure a secure communication session can be supported without revealing secrets to bystanders and eavesdroppers.

The headset 1 may include one or more proximity sensors 9 that are configured to detect when the headset is positioned on the user's head, and provide a signal to the control unit 20 when the headset is remove. As described, the control unit 20 may be configured to terminate communications (at least of private or confidential communications to the earphones and/or eyewear 4) in response to receiving a signal from one or more proximity sensors 9 indicating that the headset 1 (or other system components) is no long being worn by the user. The proximity sensor(s) 9 may be positioned on both sides of the headset so as to be located near the temple of user. In some embodiments, multiple proximity sensors 9 (not shown) may be positioned along the length of the headset 1 to provide proximity information to the control unit 20 to enable the control unit to determine whether the headset 1 is properly positioned on the users' head. If the headset 1 does not maintain proper contact with the head of the user, this will be detected by the proximity sensor(s) 9, which may relay a signal to the control unit 20 which may then disconnect the connection with the mobile or desktop system and/or stop streaming audio and/or video content in order to prevent disclosure of sensitive information anyone nearby.

Additionally, in embodiments in which the headset connected wirelessly to a mobile or desktop system, one or more proximity sensors 9 may sense the distance separating the user wearing the headset 1 to the mobile or desktop system, and suspend the session if the user moves too far away from the paired mobile or desktop system. Discontinuing secure connectivity when the user moves away from the paired mobile or desktop system will prevent infiltration by potential eavesdroppers. This separation distance determination may be based on the detected signal strength of the wireless communication link, such as Bluetooth®, through which the headset is paired, and receiving signals from the mobile or desktop system.

As illustrated in subsequent figures, proximity sensors 49, 59 may also be positioned in the eyewear 4, headphones, and mouthpiece 3.

Typically, communication links to the remote service (e.g., Citrix) providing secure information will be encrypted, with decryption of download information and encryption of upload information being performed by secure electronic device coupled to the control unit 20 of the integrated mobile confidential and secure communication environment headset 1 or other components. To prevent electronic eavesdropping on the information, the headset 1 may include a secure communication interface configured to securely connect to the secure electronic device such as a mobile device (e.g., smart phone, laptop, or tablet) or desktop computer. In some embodiments, the secure communication interface may be a wired connection 5. Any point to point wired connection 5 (e.g., USB; USB-C; HDMI, etc.) carried through shielded cables may be used to enable secure connectivity. The wired connection 5 may be shielded and also include a ferrite choke 6 to reduce any RF noise, Radio Frequency Interference (RFI) and electromagnetic interference (EMI) emitted by the system. In some embodiments, the secure communication interface may be a secure wireless communication interface configured to establish and support an encrypted communication link with a mobile device or desktop computer via a wireless communication protocol, such as Bluetooth, WIFI, or other wireless local area network (WLAN) communication link.

To protect visual content from outside viewing, the eyewear 4 may have a guard or awning (not shown) shielding peripheral sight of displayed information to maintain confidentiality. The eyewear 4 may include a camera (not shown) that may be configured to support retinal scans to authentic the user as well as detect when the eyewear 4 is removed by a user so that the system can terminate rendering information on the displays of the eyewear to provide additional security.

In some embodiments, the eyewear 4 may be electrically connected to the headset 1 and/or the headphones 2 by a data and electrical connector (not shown). In some embodiments, a direct wired connection via a shielded cable may connect the eyewear 4 to the headset 1 and/or headphones 2. In some embodiments, a shielded cable 12 may connect the headset 1 and/or headphones 2 to the mouthpiece 3. Similarly, a shielded cable wiring may couple the eyewear 4 to headphones 2 and to the mouthpiece 3. The shielded cable 12 may be selected or configured to provide RFI and EMI shielding as may be required to satisfy security standards or requirements. In some embodiments, the shielded cable 12 may be a USB protocol cable supporting USB interfaces between the headphones 2 and a microphone within the mouthpiece 3.

The headphones 2 may be noise cancelling headphones using any advanced technology to include anti-phase or active noise cancelling technology to cancel out the noise to create complete sound privacy headphones. The headphones may be made of a soundproof padding which fully covers the ears ensuring a secure seal or alternate technology which enables soundproofing. The headphones 2 may allow the user to hear information from a presentation, conference, or any audio connected to the integrated system, while preventing others from overhearing the audio. In some embodiments, the headphones 2 may include one or more proximity sensors configured to detect when the user is wearing the headphones and send a signal to the control unit 20, which the control unit may use in conjunction with signals from the headset proximity sensor 9 to determine whether the user is wearing the headphones. As described herein, the control unit 20 may be configured to disable or block sound data from being sent to the headphones 2 if the user removes the headphones while an active session of secure connectivity is on.

In some embodiments, audio data of a secure communication session may be received as encrypted data. In some embodiments, the encrypted audio data may be decrypted by the control unit 20 that then passes unencrypted audio data to speakers in the headphones 2. In some embodiments, the headphones 2 may include decryption capabilities, in which case the control unit 20 may relay the received encrypted audio data to the headphones 2 where the decryption process is performed by the decryption circuitry adjacent to or integrated within the speakers or earpieces. In this manner, RF eavesdropping of audio data can be defeated as the conductors carrying decrypted audio data are minimized. Incoming audio input is received from connected mobile/desktop system routed through the control unit to the earpiece. In some embodiments, the hardware layer encryption features of the headphones 2, speakers or earpieces may use Secure Real Time Protocol (SRTP) decryption. The key for decryption of audio input data using SRTP encryption may be obtained through Z and Real Time Protocol (ZRTP) which may be implemented in the control unit 20.

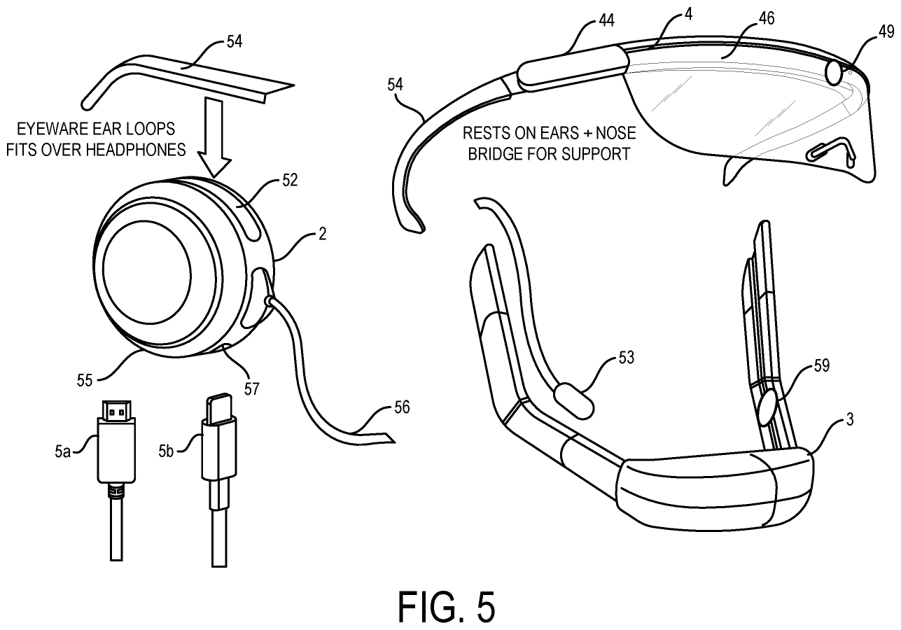

A sound canceling mouthpiece 3 may be coupled to or integrated in the headset 1, the eyewear 4 and/or the headphones 2: The purpose of the mouthpiece 3 is to make speech confidential and private. The mouthpiece 3 may be integrated to the headphones 2 allowing what is being spoken to be clearly heard. The mouthpiece 3 may include a microphone or unaided augmentative/alternative communications built into a soundproof padded enclosure that covers the mouth. An example of a microphone 53 is illustrated in FIG. 5. The communication built into a soundproof padded enclosure covering the mouth may allow for better capturing of speech by a microphone to support speech to text software. The soundproof padding in the mouthpiece 3 may ensure that the speech remains confidential by preventing the user's speech from being overheard by others. The mouthpiece 3 may be hands-free ensuring a tight seal around the mouth to prevent the user's voice from being heard.

In some embodiments, the mouthpiece 3 may include one or more proximity sensors configured to detect when the user is wearing the mouthpiece 3 and send a signal to the control unit 20, which the control unit may use in conjunction with signals from the headset proximity sensor 9 to determine whether the user is wearing the mouthpiece 3. As described herein, the control unit 20 may be configured to disconnect from a paired mobile or desktop device if the user removes the mouthpiece 3 during an active session of secure connectivity is on.

In some embodiments, the mouthpiece 3 may include a microphone configured with built-in digital signal processing capabilities with hardware layer encryption features to enable real-time encryption of the user's voice before passing the voice data to the control unit 20. In some embodiments, the hardware layer encryption features of the mouthpiece 3 may use SRTP encryption. The key for encryption of audio input data using SRTP encryption may be obtained through ZRTP which may be implemented in the control unit 20. In such embodiments, the mouthpiece 3 captures audio input, encrypts the audio to digital encrypted format and then securely transmits the encrypted data through the control unit 20 to the connected mobile or desktop system to be transported to a remote server supporting the secure communication session. Similar decryption process of audio input happens when incoming audio input is received from connected mobile/desktop system routed through the control unit to the earpiece. In this case, the control unit shares the decryption key with the headphones 2, which then decrypts the data transported through SRTP technique, and converts digital audio data to analog sound waves for the user.

Upon connecting the headset 1 (and/or the headphones 2, shielded mouthpiece 3 and/or eyewear 4) to a mobile device or desktop computer, the display of information and sound generated by the mobile device or desktop computer maybe shifted to the eyewear 4 and the headphones 2, and audio input shifted to the shielded microphone within the mouthpiece 3. While the mobile device or desktop may run the desired software (e.g., Citrix®) the eyewear 4 may replace the use of the device screen and the headphones may replace the device audio.

To protect information and create a virtual operating system, the mobile device or desktop, while connected to the headset 1, may securely access all sanctioned applications through an end-to-end encrypted and decryption capability, which could be hosted on a secure cloud or a data center. The integrated system may access a virtual operating system ensuring that all the data and information are never stored or retained on the mobile device or desktop, but rather retained on a secure cloud or in a data center that can be monitored and controlled.

As described above, the control unit may also be configured to recognize when a communication session is limited to either visual-only information or audio-only information and, in response, enable or discontinue the communication session based on the proximity sensor in in the eyewear 4 but not the earphones 2 in visual-only sessions, or enable or discontinue the communication session based on the proximity sensor in the earphones 2 but not the eyewear in audio-only sessions.

The mouthpiece 3 may include sound shielding to muffle the sound of the user's voice. The mouthpiece 3 may include a mute/unmute button 13 that enables the user to toggle between muting and unmuting a microphone within the mouthpiece 3. In some embodiments, the mouthpiece 3 may include a capability to generate masking sounds that may be emitted by a speaker 14 to mask the sound of the user's voice, further preventing anyone from eavesdropping on the user's words. The masking noise may be louder that the users natural speech note, which the control unit 20 may detect and adjust the volume on the external speaker module accordingly. The masking sounds may emanate from the speaker 14 to create a white or pink noise like sound. The external masking capability (e.g., white or pink noise) may be controllable to provide the user various volume levels through a white noise or pink control interface 15. The external masking noise may not be detected by the microphone inside the mouthpiece 3, thus preventing interference with the user's speech.

In order to create an end-to-end encrypted capability, the virtual operating program (e.g., Citrix®) residing on the mobile or desktop system and the headset 1 may authenticate each other. Any suitable end to end method can be used to provide encryption and decryption to support an end-to-end secure link via a mobile device or desktop computer to the virtual operating system. In order to establish two factor authentication of the user, the headset may include sensors configured to support biometric authentication of the user, such as obtaining a retinal scan, fingerprint scan, and/or voice print.

The eyewear 4 may be worn like glasses or goggles that wrap around the ear with the noise cancelling headphones. From the headphones 2 there may be a wired connection 12 (e.g., a USB cable) to the hands-free mouthpiece 3. The three elements of the headphones 2, mouthpiece 3 and eyewear 4 may be fully integrated and interconnected within the headset 1. Upon turning on the headset 1 and connecting it to a mobile device or desktop, the three elements (eyewear 4, headphones 2, and mouthpiece 3) may initiate a virtual visual display, and private and secure hearing and voice capability.

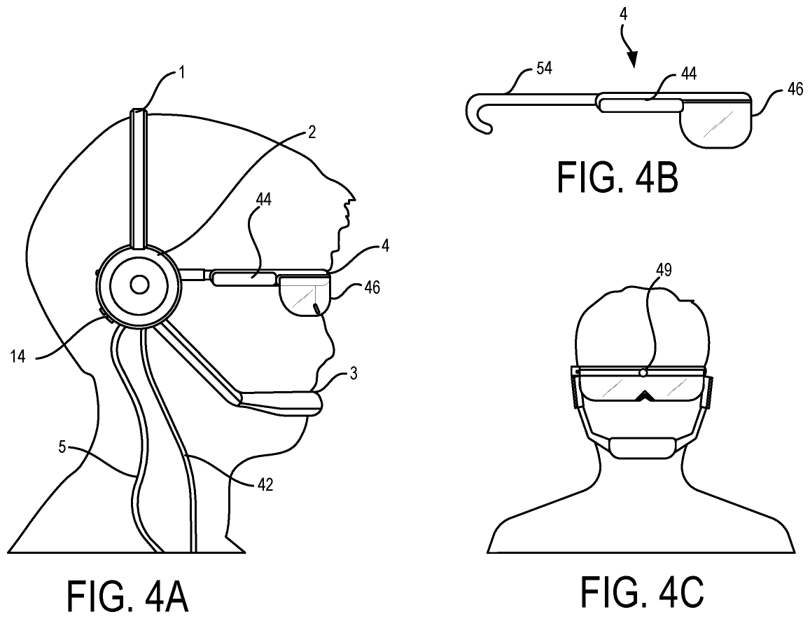

The eyewear 4 may include an image projector and lenses (e.g., illustrated in FIG. 4) that have a one way privacy film that lets the user you a projected image while seeing through the glasses so that the user can use a keyboard or mouse while operating the headset 1. The eyewear 4 may include a retinal scanner for capturing biometric signature of the user eye for further authentication purposes while the user is using the embodiment for an active session. These authentication mechanisms will also allow system integrators to create multi-level authentication processes appropriate for the degree of sensitive data being consumed by the user.

Device Application Setup: The first time this headset 1 (along with the headphones 2, shielded microphone 3 and/or eyewear 4) is connected to a mobile device or desktop it may need to be registered. During the registration process the user may be prompted to register their retina and thumbprint via a biometric scanner 7, which can be used for using biometric information for multi-factor authentication (MFA). The user may also be prompted to speak certain key words or sentences during the registration process for use in later voice recognition and continuous authentication purposes. These user biometric samplings may be a onetime setup for a user and after which the system may be ready for usage.

Device Usage process flow: The user connects the headset 1 (and/or the headphones 2, shielded microphone 3 and/or eyewear 4) using a secure wired or wireless connection to a mobile device or desktop and turns on the headset 1. When a user connects to a secure network, the user may be prompted to enter login credentials. After the user has entered login credentials, the user may be prompted to wear the eyewear 4. After the user has put on the eyewear 4 an application may prompt the user to start a retinal can and/or a thumbprint scan for multifactor authentication using a biometric scanner 7 or a retinal scanner positioned within the eyewear 4. On successful authentication of the user and the headset 1, the screen and audio of the connected mobile device or desktop computer may be disabled and turned off, and all video may be routed to the eyewear 4, all voice or sound may be routed to the headphones 2, and audio input may only come from the mouthpiece 3.

The user authentication process may be done continuously to ensure that only the targeted user is able to use the headset. At any point during usage of the headset 1, if the contact sensors 9 indicate that the headset 1 is no longer on the user's head or become disabled, the secure connection to the mobile device or desktop computer will be automatically disconnected.

Voice biometric analysis may also be incorporated in the control unit 20, which may continuously match voice samples of the user to voice samples collected during the registration process. The control unit 20 may be configured with capability to segregate user voice and patterns even in environments where there is noise or interference, or when an imposter attempts to impersonate the authorized user. In situations in which the speak for some time, and thus the control unit 20 does not receive a voice input for voice print authentication for configurable length of time, system may prompt the user (e.g., through a simulated voice emitted through the earphones) to speak an authentication phrase to enable reauthentication. Alternatively, the user may be prompted to perform another biometric authentication method (e.g., touch a fingerprint scanner or enter a password) for reauthentication.

These methods of detecting when the user removes a piece of the system and/or periodically reauthenticating the user during a secure communication may be performed as background processes in the control unit 20 throughout the active period of a secure communication session and serve to further guard against leakage or disclosure of confidential information.

The integrated mobile confidential and secure communication environment may also provide logs of all actions and changes done by the user for audit and tracking. Such logs may be stored within internal memory and/or may be communicated to a mobile device or desktop computer via a secure wired or wireless communication link to be stored on cloud platform.

To control volume through the headphones 2, the user may touch volume up/down buttons 10, such as positioned on a support arm of the eyewear 4. Further, the headset 1 may include other user interfaces or buttons 11 for controlling the display or other functions. Additional user interfaces (e.g., buttons, dials, lights, displays, speakers, etc.) may be associated with further functionalities, such as mute, power on/off, battery charging, battery charge state, minimal central processor unit (CPU) required to store and share information, white noise, voice detection, and voice alternating capability. For example, the integrated mobile confidential and secure communication environment may include color coded lights configured to show that the device is properly integrated and connected to the user's electronic device.

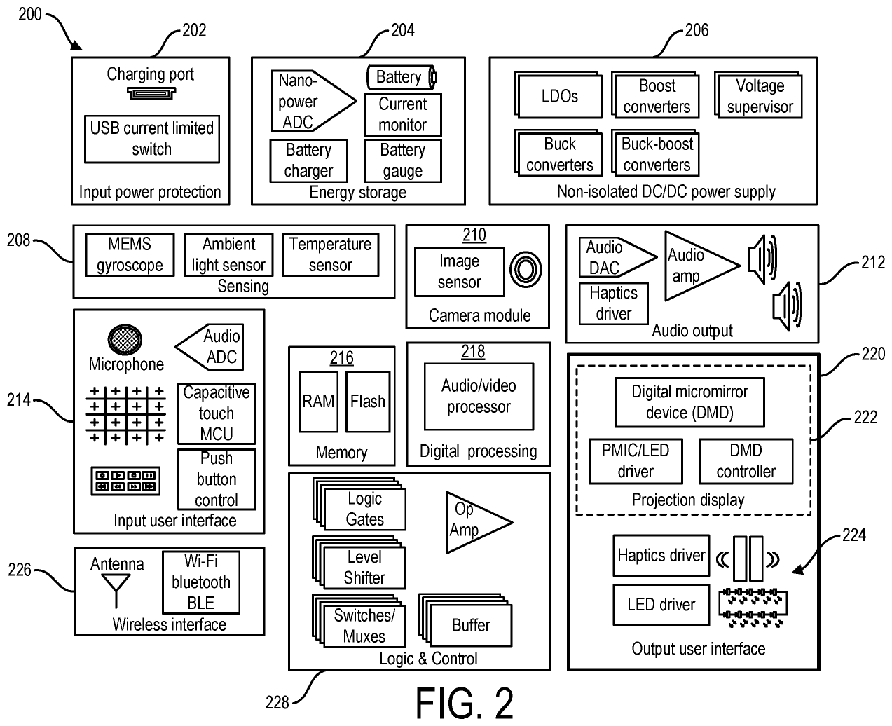

FIG. 2 is a functional block diagram illustrating examples of software modules, functionality and software subsystems that may be configured to perform as an integral software platform 200 executes in one or more processors to provide the functionality supporting an integrated mobile confidential and secure communication environment according to various embodiments. Such software modules, functionality and software subsystems may be implemented within and executed by one or more processors (not shown separately) integrated within one or more components within the headset 1, headphones 2, mouthpiece 3 and/or the eyewear 4. For example, one or more processors of an integrated mobile confidential and secure communication environment may execute software modules including one or more of: an input power protection module 202; and energy storage control module 204; a non-isolated DC/DC power supply control module 206; a sensor monitoring and control module 208; a camera control and processing module 210; and audio processing and output module 212; and a user input interface module 214; memory 216; digital processing 218; a user output interface module 220, which may include a control module four projection display 222 and output controllers 224; a wireless interface control module 226; and/or various logic and control modules 228. FIG. 2 illustrates nonlimiting examples of different components and software elements/functionality that may be included in each of these example software modules. Various embodiments many have other (additional) or fewer software modules, functionality and software subsystems.

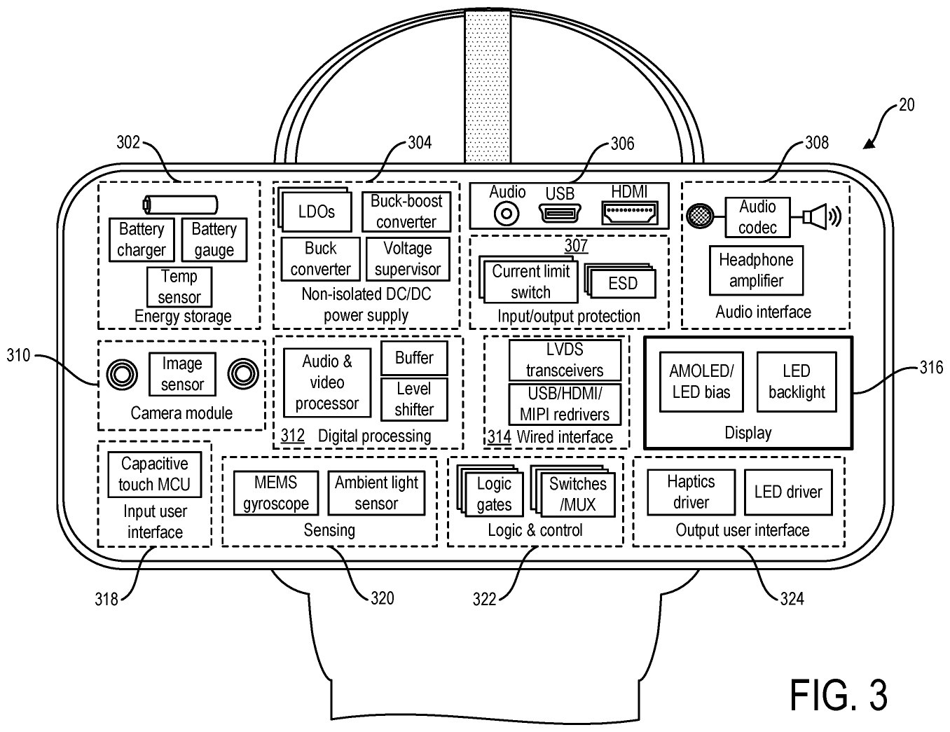

FIG. 3 is a hardware block diagram illustrating examples of hardware components and subsystems that may be coupled or integrated together within a control unit 20, such as within the headset 1, to provide the functionality to support an integrated mobile confidential and secure communication environment according to various embodiments. Such components and subsystems may be integrated within or coupled to the headset 1, headphones 2, mouth piece 3 and/or the eyewear 4. For example, an integrated mobile confidential and secure communication environment may include one or more of: an energy storage subsystem 302 (e.g., a battery, battery charger, battery gauge and temperature sensor); a non-isolated DC/DC power supply 304; input/output interfaces 306; input/output protection circuits 307; audio interface circuitry (e.g., audio codec, headphone amplifier, etc.); a camera module 310 (e.g., including an image sensor or camera); one or more digital processing units 314; a display and display complements 316; one or more user input interfaces 318; various sensors 320 (e.g., gyroscopes, accelerometers, light sensors, etc.); various logic and control modules 322 and/or one or more user output interfaces 324. In various embodiments, the hardware components and subsystems may be implemented in one or more integrated circuits, one or more system-on-chip devices, and/or one or more circuit boards. Also, the various components may be packaged within a shielded housing and/or connected via shielded cables so as to minimize or prevent leakage of electromagnetic signals. Various embodiments many include other (additional) or fewer hardware components and subsystems.

FIGS. 4A-4C are diagrams illustrating major components of a first alternative example embodiment. In this illustrated embodiment, the headphones 2 and mouthpiece 3 are integrated together in a headset 1 with the eyewear 4 configured as a separate unit as illustrated in FIG. 4B. The eyewear 4 may be configured to connect to and receive data and commands from the control unit 20 (see FIGS. 1, 3). The eyewear 4 may include an image projector 44 positioned and configured to project images on the lenses 46 in a manner that can be viewed by the user. As noted above, the lenses 46 may include a surface coating that enables the user to view projected images while looking through the lenses, such as to view a keyboard, an object being worked on, or objects in the distance (e.g., the roadway while operating a vehicle). In some embodiments, such a surface coating may also prevent the images from being viewed from the outside by others. As nonlimiting examples, the image projector 44 may be the same as or similar to image projectors in the Vuzix® smart glasses made by Vuzix Corporation, Iristick® smart glasses manufactured by Iristick NV, or similar commercial products. In the embodiment illustrated in FIG. 4, power may be provided to the headset 1 via a separate charging cable 42.

In some embodiments, the eyewear 4 may include one or more proximity sensors 49 that is/are configured to detect when the user is wearing the eyewear and send a signal to the control unit 20 when either the eyewear is being worn or when the eyewear is removed by the user. This signal may be of a format that can be used by the control unit 20, in some embodiments in conjunction with signals from the headset proximity sensor 9, to determine whether the user is wearing the system. If the user removes the eyewear 4 while an active session of secure connectivity is on, the control unit 20 may receive a signal to that effect from the proximity sensor 49 and in response discontinue rendering of visual information and/or disconnect the secure connection. In some embodiments, the proximity sensor 49 may be a contact sensor configured to sense direct contact with the forehead of the user. In some embodiments, the proximity sensor 49 may be a capacitance or reluctance sensor configured to sense a change in electric field from being positioned close to the forehead of the user. In some embodiments, the proximity sensor 49 may be a camera positioned and configured to image a portion of the user's face, such as the eyes, and use such camera images to determine when the eyewear 4 is being worn by the user. In some embodiments, such a camera may also be used for identifying or authenticating the user, such as by imaging an retina or pupil of the user and comparing the pattern to a pattern of the user's eye stored in memory (e.g., within memory of the control unit 20).

FIG. 5 is a diagram illustrating selected components of the first alternative example embodiment. As shown in this figure, the eyewear 4 ear temples 54 may fit into a groove 52 within the headphones 2. Such groove may include electrical contacts to provide a secure data communication interface between circuitry in the eyewear 4 (e.g., the image projector 44, the proximity sensor 49, etc.) and circuitry in the headphones 2. For example, the electrical contacts within the groove 52 may include contacts for a VGA, HTML or other video cable to support transmission of image data to the projector 44.

FIG. 5 also illustrates an example of how a microphone 53 may be positioned within the mouthpiece 3, with the mouthpiece 3 serving to block the sound of the user's voice from being overheard by others. In some embodiments, the microphone 53 may be coupled via a USB cable 56 to circuitry within the headphones 2.

FIG. 5 also illustrates an embodiment in which the mouthpiece 3 includes one or more proximity sensors 59 that is/are configured to detect when the user is wearing the mouthpiece 3 and send a signal to the control unit 20 when either the mouthpiece is being worn or when the mouthpiece is removed by the user. This signal may be of a format that can be used by the control unit 20, in some embodiments in conjunction with signals from the headset proximity sensor 9, to determine whether the user is wearing the system. If the user removes the mouthpiece 3 while an active session of secure connectivity is on, the control unit 20 may receive a signal to that effect from the proximity sensor 59 and in response disconnect the secure connection. In some embodiments, the proximity sensor 59 may be a contact sensor configured to sense direct contact with the face of the user. In some embodiments, the proximity sensor 59 may be a capacitance or reluctance sensor configured to sense a change in electric field from being positioned close to the face of the user.

FIG. 5 also illustrates examples of cables providing connections to a smart phone or desktop computer, which may include an HDMI cable 5a that connects to an HDMI socket 55 in the headphones 2, and/or a USB-C cable 5b that connects to a USB-C socket 57 in the headphones 2.

FIG. 6A is a diagram illustrating major components of a second alternative example embodiment. As shown in FIG. 6A, the headphones 2 may be replaced with earbuds 62, which may be coupled to a control unit 63 that may include the cable interfaces 55, 57 or connecting to a cable (e.g., HDMI 5a, USB-C 5b, etc.) for connecting to a smart phone or desktop computer. In this embodiment, the eyewear 4 may be a separate unit from the earbuds 62, control unit 63 and mouthpiece 3. For example, the earbuds 62, earbud controller 63 and mouthpiece 3, including a microphone 53 within the mouthpiece, may be supported on the user's head by a first strap 1a, while the eyewear 4 is supported on the user's head by the second head strap 1b. In some embodiments, the control unit 20 may be included within or as part of the earbud controller 63. The second head strap 1b supporting the eyewear 4 may include a length adjustment structure 67 that enables a user to adjust the band to fit the user's head. In some embodiments, the earbuds 62 may include a sensor configured to detect or recognize when the earbuds are inserted in the use's ears, and signal (e.g., to the control unit) when either of the earbuds is removed from the user's ear. This signal may enable the control unit to terminate sending sound data to the earbuds when the user removes one or both of the earbuds 62, thereby providing security for auditory data.

In embodiments such as illustrated in FIG. 6A in which the eyewear 4 is configured as a separate unit, communications image data from the control unit 65 to the eyewear 4, and optionally eye tracking or iris scan data from sensors within the eyewear 4 to the control unit 20, may be accomplished via a wireless communication link (e.g., Wi-Fi, Bluetooth, etc.). Such embodiments may be appropriate in circumstances in which electronic eavesdropping of image data is not of concern or a realistic risk. In some embodiments, an optional shielded cable (e.g., HDMI or USB-C not shown) may be provided for connecting the eyewear 4 to the control unit 20 when there is a risk of electronic eavesdropping of image data.

FIG. 6B illustrates details of an embodiment for the mouthpiece 3 to provide sound buffering to prevent or limit eavesdropping of user's voice. Example, similar to soundproof window technology, the mouthpiece may include a first panel 64 of a sound buffering polymer membrane, and a second panel 66 of a sound buffering polymer membrane (either the same type of polymer or a different polymer than the first panel 64), with the two panels separated by an edge seal 65, thereby forming a gap between the first panel 64 and the second panel 66.

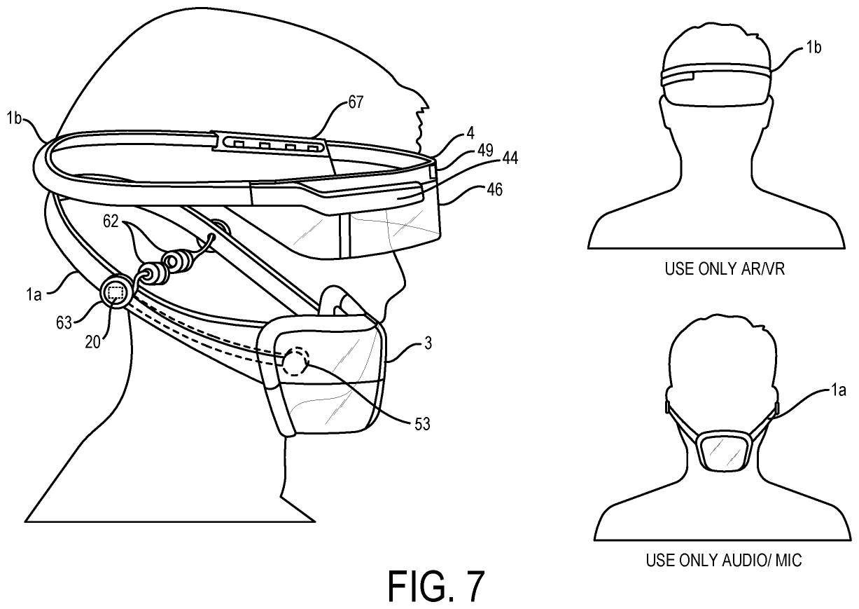

FIG. 7 is a diagram illustrating the embodiment illustrated in FIG. 6A while being worn by a user. In particular, FIG. 7 illustrates that in some circumstances, a user may only wear the audio assembly, including the earbuds 62, mouthpiece 3 and microphone 53, such as when a voice call is going to be conducted without any video. Also, FIG. 7 illustrates that a user may only wear the eyewear 4, such as when a communication is only going to involve visual information.

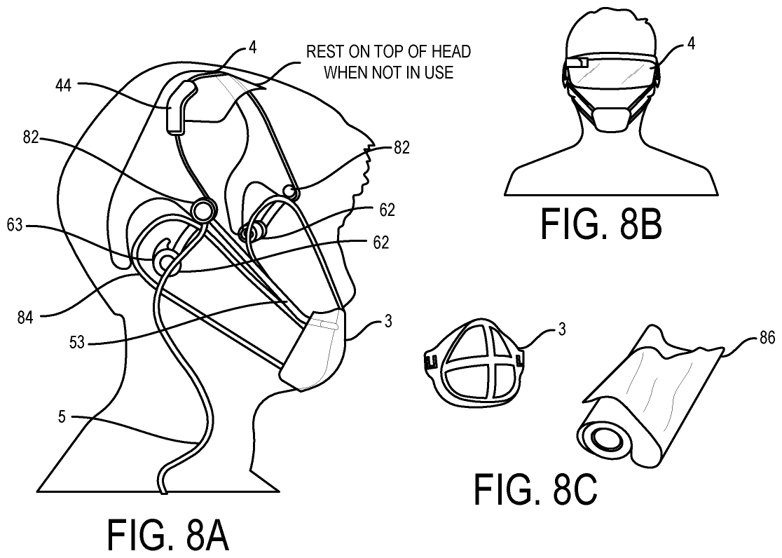

FIG. 8A is a diagram illustrating major components of a third alternative example embodiment. In the embodiment shown in FIG. 8A, the headset 1 integrates the audio output in the form of earbuds 62 with the eyewear 4 as a single unit, while the mouthpiece 3 is configured as a removable mask with your straps 84 that can be placed over the user's ears. In this embodiment, the eyewear 4 is configured with a pivot 82 on the control unit 63 that enables the eyewear 4 to be rotated up to rest on the user's head when not in use as illustrated in FIG. 8A. This position of the eyewear 4 may be preferred by a user when no visual content is being shared. The eyewear 4 may be rotated down over the eyes as illustrated in FIG. 8B when visual information is going to be presented to the user.

FIG. 8C illustrates an embodiment of the mouthpiece 3 in which the mouthpiece provides an internal structural frame on or within which vinyl sound absorbing material 86 may be placed when in use. The use of vinyl sound absorbing material within a mask internal structural frame may provide hygiene benefits as the material can be replaced after each use.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Any reference to claim elements in the singular, for example, using the articles “a,” “an,” or “the” is not to be construed as limiting the element to the singular.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A mobile confidential and secure communication environment system, comprising:
eyewear coupled to the headset, wherein the eyewear comprises a display that is configured to display images for viewing by a user while preventing such imagery to be viewed by others;
headphones coupled to the headset and configured to provide audio to the user while preventing sounds from being overheard by other;
a mouthpiece including a microphone configured to receive speech spoken by the user while preventing such speech from being overheard by others;
a secure communication interface configured to provide a secure communication link to a mobile device or desktop computer; and
a control unit coupled to the eyewear, headphones, mouthpiece and secure communication interface, wherein the control unit is configured to control operations of the eyewear, headphones and mouthpiece to enable secure communications during a secure communication session.

2. The mobile confidential and secure communication environment system of claim 1, further comprising a headset configured to be worn by the user, the headset comprising the control unit and a proximity sensor configured to detect when the headset is positioned on the head of the user and provide a signal to the control unit when the headset is removed from the head of the user, wherein the control unit is configured to terminate the secure communication session in response to the signal that the headset is removed from the head of the user.

3. The mobile confidential and secure communication environment system of claim 1, wherein the eyewear comprises a proximity sensor configured to detect when the eyewear is being worn by the user and provide a signal to the control unit when the eyewear is removed by the user, wherein the control unit is configured to terminate the secure communication session in response to the signal that the eyewear is removed by the user.

4. The mobile confidential and secure communication environment system of claim 1, wherein the mouthpiece comprises a proximity sensor configured to detect when the mouthpiece is being worn by the user and provide a signal to the control unit when the mouthpiece is removed by the user, wherein the control unit is configured to terminate the secure communication session in response to the signal that the mouthpiece is removed by the user.

5. The mobile confidential and secure communication environment system of claim 1, wherein the headphones comprises a proximity sensor configured to detect when the earphones are being worn by the user and provide a signal to the control unit when the headphones are removed by the user, wherein the control unit is configured to terminate the secure communication session in response to the signal that the headphones are removed by the user.

6. The mobile confidential and secure communication environment system of claim 1, wherein the control unit is configured to authenticate the user using a biometric authentication method prior to enabling commencement of the secure communication session.

7. The mobile confidential and secure communication environment system of claim 1, wherein:
the control unit is positioned within the headphones;
the eyewear is separable from the headphones;
the headphones include slots into which temples of the eyewear can fit when both are worn by a user;
the slots include electrical contacts coupled to circuitry within the headphones; and
the temples of the eyewear include electrical contacts configured to make electrical connections with the electrical contacts in the slot when the temples are positioned in the slots.

8. The mobile confidential and secure communication environment system of claim 1, wherein the control unit comprises:
a transceiver configured to send and receive audio and visual communications via one of a wireless or wired communication link;
a memory; and
a microcontroller unit coupled to the transceiver and the memory and configured with processor-executable instructions stored in the memory to perform operations comprising:
managing data communications with the eyewear, headphones, and mouthpiece;
decrypt received encrypted audio and visual data for presentation on the headphones and eyewear, respectively;
encrypt speech sounds received from the microphone for secure transmission via the transceiver;
determining based on signals from the one or more proximity sensors whether the headphones, eyewear and mouthpiece are being worn by the user;
enabling communications via the transceiver, sending audio to the headphones, sending video to the eyewear, and receiving sound from the mouthpiece in response to determining that the headphones, eyewear and mouthpiece are being worn by the user; and
disable communications via the transceiver, preventing sending audio to the headphones, preventing sending video to the eyewear and preventing receiving sound from the mouthpiece in response to determining that any one of the headphones, eyewear and mouthpiece are not being worn by the user.

9. The mobile confidential and secure communication environment system of claim 8, wherein the microcontroller unit is further configured to terminate the secure communication session in response to separation distance to a mobile or desktop device supporting the session exceeds a threshold distance.
